(19) United States
(12) Patent Application Publication
(10) Pub. No.: US 2024/0323025 A1
(43) Pub. Date: Sep. 26, 2024

(54) HASH GENERATION DEVICE, HASH DETERMINATION DEVICE, AND SYSTEM

(71) Applicant: Sony Semiconductor Solutions Corporation, Kanagawa (JP)

(72) Inventors: Toshiki Itagaki, Kanagawa (JP); Nobuo Nakamura, Kanagawa (JP)

(21) Appl. No.: 18/575,368

(22) PCT Filed: Mar. 4, 2022
(86) PCT No.: PCT/JP2022/009402

§ 371 Date: Dec. 29, 2023

(30) Foreign Application Priority Data
Jul. 7, 2021 (JP) 2021-112533

(51) Int. Cl. H04L 9/32

(52) U.S. Cl. CPC H04L 9/3236

(57) ABSTRACT

Detection capability of falsification of data is improved. A hash generation device includes a reference hash information generation unit and a reference hash generation unit. The reference hash information generation unit included in the hash generation device generates a plurality of pieces of reference hash information by a common process according to data, the plurality of pieces of reference hash information being information of a reference hash that is a hash generated from the data and is for use in determination of falsification of the data. The reference hash generation unit included in the hash generation device generates the reference hash on a basis of the generated reference hash information.

### FIELD

The present disclosure relates to a hash generation device, a hash determination device, and a system. Specifically, the present disclosure relates to a hash generation device, a hash determination device, and a system using these devices.

### BACKGROUND

A system that acquires data of multimedia or the like via a server or the like is used. For example, a system has been proposed in which a length or the like of a fingerprint is dynamically set according to a lifetime of multimedia and used for search (see, for example, Patent Literature 1).

### CITATION LIST

### Patent Literature

Patent Literature 1: US 2012/278326 A

### SUMMARY

### Technical Problem

However, in the above-described conventional technology, since data (hash) for detecting falsification is only one-dimensional, there is a problem that it is difficult to detect falsification of data.

Accordingly, the present disclosure proposes a hash generation device, a hash determination device, and a system that improve detection capability of falsification of data.

### Solution to Problem

The present disclosure has been conceived to solve the problem described above, and the aspect thereof is a hash generation device includes: a reference hash information generation unit that generates a plurality of pieces of reference hash information by a common process according to data, the plurality of pieces of reference hash information being information of a reference hash that is a hash generated from the data and is for use in determination of falsification of the data; and a reference hash generation unit that generates the reference hash on a basis of the generated reference hash information.

### BRIEF DESCRIPTION OF DRAWINGS

FIG. 1 is a diagram illustrating a configuration example of a system according to a first embodiment of the present disclosure.

FIG. 2 is a diagram illustrating a basic configuration example of a hash generation device according to the first embodiment of the present disclosure.

FIG. 3 is a diagram illustrating a basic configuration example of a hash determination device according to the first embodiment of the present disclosure.

FIG. 4 is a diagram illustrating an example of hash generation processing according to the first embodiment of the present disclosure.

FIG. 5 is a diagram illustrating an example of hash determination processing according to the first embodiment of the present disclosure.

FIG. 6 is a diagram illustrating a configuration example of a hash generation device according to a second embodiment of the present disclosure.

FIG. 7 is a diagram illustrating an example of a shape of a filter kernel according to the second embodiment of the present disclosure.

FIG. 8 is a diagram illustrating a configuration example of a hash generation device according to a third embodiment of the present disclosure.

FIG. 9 is a diagram illustrating a configuration example of a hash generation device according to a fourth embodiment of the present disclosure.

FIG. 10 is a diagram illustrating another configuration example of the hash generation device according to the fourth embodiment of the present disclosure.

FIG. 11 is a diagram illustrating an example of a shape of a block according to the fourth embodiment of the present disclosure.

FIG. 12 is a diagram illustrating a configuration example of a hash generation device according to a fifth embodiment of the present disclosure.

FIG. 13 is a diagram illustrating an example of a shape of a block according to the fifth embodiment of the present disclosure.

FIG. 14 is a diagram illustrating a configuration example of a hash generation device according to a sixth embodiment of the present disclosure.

FIG. 15 is a diagram illustrating a configuration example of a hash generation device according to a seventh embodiment of the present disclosure.

FIG. 16 is a diagram illustrating an example of a projection center according to the seventh embodiment of the present disclosure.

FIG. 17 is a diagram illustrating a configuration example of a hash generation device according to an eighth embodiment of the present disclosure.

FIG. 18 is a diagram illustrating a configuration example of a hash generation device according to a ninth embodiment of the present disclosure.

FIG. 19 is a diagram illustrating an example of the number of feature amounts of feature amount groups according to the ninth embodiment of the present disclosure.

FIG. 20 is a diagram illustrating a configuration example of a hash generation device according to a tenth embodiment of the present disclosure.

FIG. 21 is a diagram illustrating a schematic configuration example of a hash generation device according to an eleventh embodiment of the present disclosure.

FIG. 22 is a diagram illustrating a configuration example of a hash generation device according to a twelfth embodiment of the present disclosure.

FIG. 23A is a diagram illustrating an example of a hash region according to the twelfth embodiment of the present disclosure.

FIG. 23B is a diagram illustrating another example of the hash region according to the twelfth embodiment of the present disclosure.

FIG. 24 is a diagram illustrating a configuration example of a hash determination device according to the twelfth embodiment of the present disclosure.

FIG. 25 is a diagram illustrating an example of an effect according to the twelfth embodiment of the present disclosure.

FIG. 26 is a diagram illustrating an example of a hash space according to the twelfth embodiment of the present disclosure.

FIG. 27 is a diagram illustrating another example of an effect according to the twelfth embodiment of the present disclosure.

FIG. 28 is a diagram illustrating a configuration example of a system according to a modification example of the embodiment of the present disclosure.

FIG. 29 is a diagram illustrating another configuration example of a system according to a modification example of the embodiment of the present disclosure.

### DESCRIPTION OF EMBODIMENTS

Hereinafter, an embodiment of the present disclosure will be described in detail with reference to the drawings. The description will be given in the following order. Note that in each of the following embodiments, the same parts are denoted by the same reference numerals, and redundant description will be omitted.
1. First Embodiment
2. Second Embodiment
3. Third Embodiment
4. Fourth Embodiment
5. Fifth Embodiment
6. Sixth Embodiment
7. Seventh Embodiment
8. Eighth Embodiment
9. Ninth Embodiment
10. Tenth Embodiment
11. Eleventh Embodiment
12. Twelfth Embodiment
13. Modification Example

### 1. First Embodiment

### [Configuration of System]

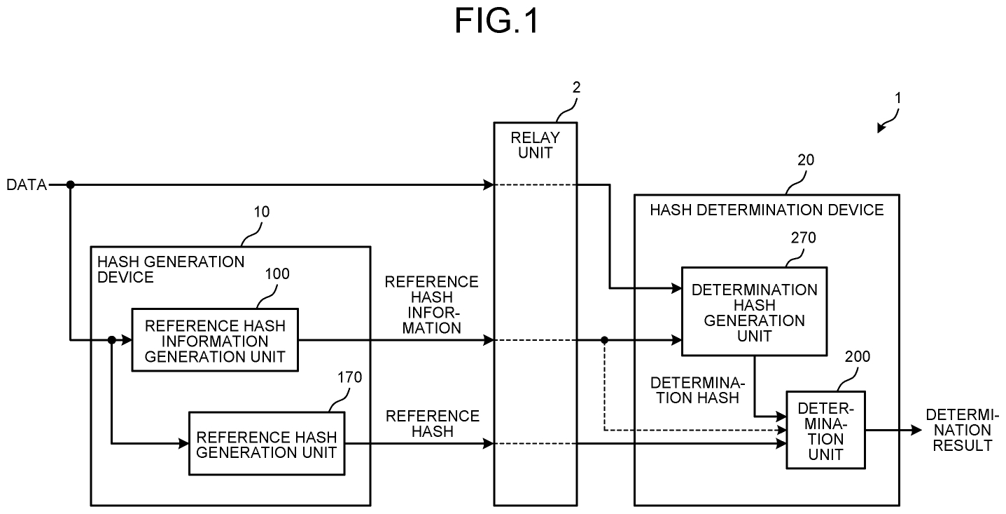

FIG. 1 is a diagram illustrating a configuration example of a system according to a first embodiment of the present disclosure. The drawing is a block diagram illustrating a schematic configuration example of the system 1. The system 1 includes a hash generation device 10 and a hash determination device 20. Note that a relay unit 2 is further illustrated in the drawing. The relay unit 2 corresponds to, for example, a network including a server. A distributor distributes data of multimedia or the like via the relay unit 2. Then, the user acquires data held in a server or the like of the relay unit 2. At this time, the data held in the server of the relay unit 2 may be falsified against the intention of the distributor. Therefore, the distributor generates a hash on the basis of the data and distributes the hash. The user can determine falsification of the data on the basis of the delivered hash.

Here, the hash is a unique value generated for target data, and is a value for identifying data. This hash is generated by a hash function and is configured to have a short word length for data.

Systems that use this hash have two perspectives: robustness and sensitivity to content changes. The robustness represents a property that a hash does not change with respect to specific processing for data such as multimedia. Here, this specific processing is referred to as processing recognized as robust. The processing recognized as robust is, for example, processing such as lossy compression, and is predetermined processing. Further, sensitivity to content change is that a hash is different for multimedia having different content. The robustness and the sensitivity to content change are in a trade-off relationship. In a hash intended to detect falsification, the detection capability of falsification can be improved by increasing the difference between the hash before falsification and the hash after falsification.

The hash generation device 10 in the drawing generates a reference hash which is a hash for use in determination of falsification of data. In addition, the hash determination device 20 in the drawing determines whether or not data is falsified. In the system of the drawing, the ability to detect falsification is improved using a multi-dimensional hash of two or more dimensions. Here, multi-dimensionalization into two or more dimensions means that a plurality of pieces of data is associated with each other to form two-dimensional or more information for use in hash generation and determination. In addition, “two or more dimensions” means that two or more groups exist when a bit string of data is divided into bit strings having a carry relationship. Associating a plurality of pieces of data with each other means applying the same processing to a plurality of pieces of data. In a case where the same processing is not applied, a plurality of processes is executed for a plurality of pieces of data, and the cost of implementation of processes increases. Therefore, the number of pieces (dimensions) of data that can be processed per mounting cost of processing is reduced.

In the system illustrated in the drawing, reference hash information that is a plurality of pieces of information associated with each other is used as information at the time of generating a hash. The hash generation device 10 generates the reference hash information and generates the reference hash from data on the basis of the reference hash information. On the other hand, the hash determination device 20 generates a determination hash on the basis of the reference hash information for data (hereinafter referred to as query data) acquired via the relay unit 2 or the like. This determination hash is a hash generated from data acquired on the user side. By comparing the determination hash with the reference hash, falsification of the query data can be detected.

The hash generation device 10 includes a reference hash information generation unit 100 and a reference hash generation unit 170.

The reference hash information generation unit 100 generates the above-described reference hash information. The generated reference hash information is transmitted to the hash determination device 20 via the relay unit 2 and the like.

The reference hash generation unit 170 generates a reference hash on the basis of the reference hash information. The generated reference hash is transmitted to the hash determination device 20 together with the reference hash information.

The hash determination device 20 includes a determination hash generation unit 270 and a determination unit 200.

The determination hash generation unit 270 generates a determination hash that is a hash of the query data on the basis of the reference hash information.

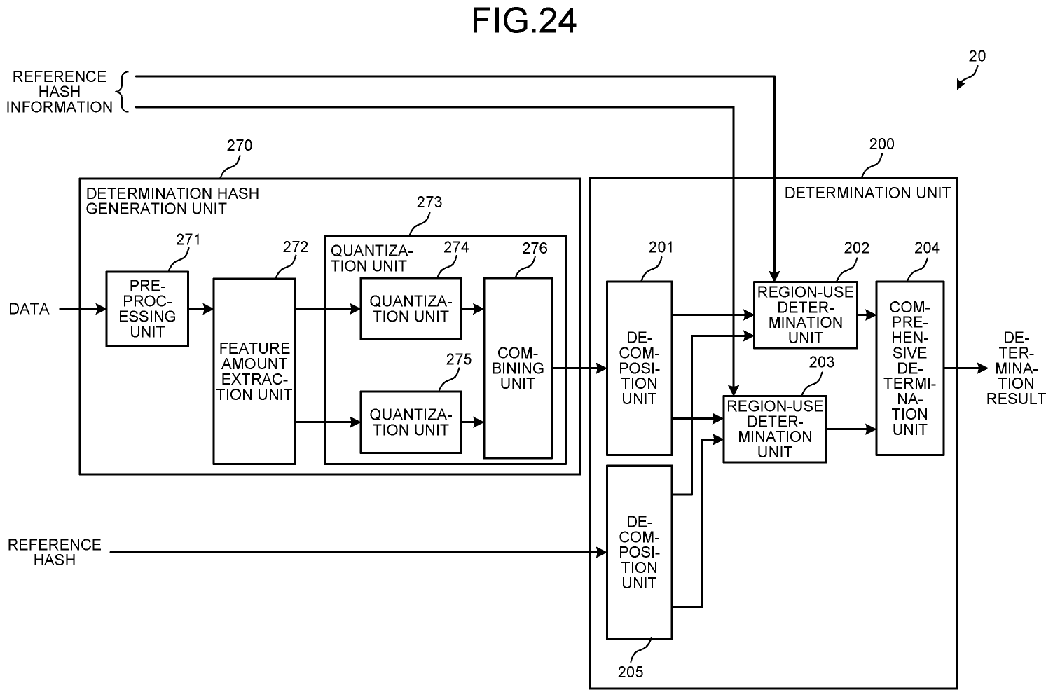

The determination unit 200 determines falsification of the query data on the basis of the determination hash and the reference hash. Note that, as will be described later with reference to FIG. 24, the determination unit 200 can also employ a configuration of detecting falsification of the query data on the basis of the determination hash, the reference hash, and the reference hash information.

### [Basic Configuration of Hash Generation Device]

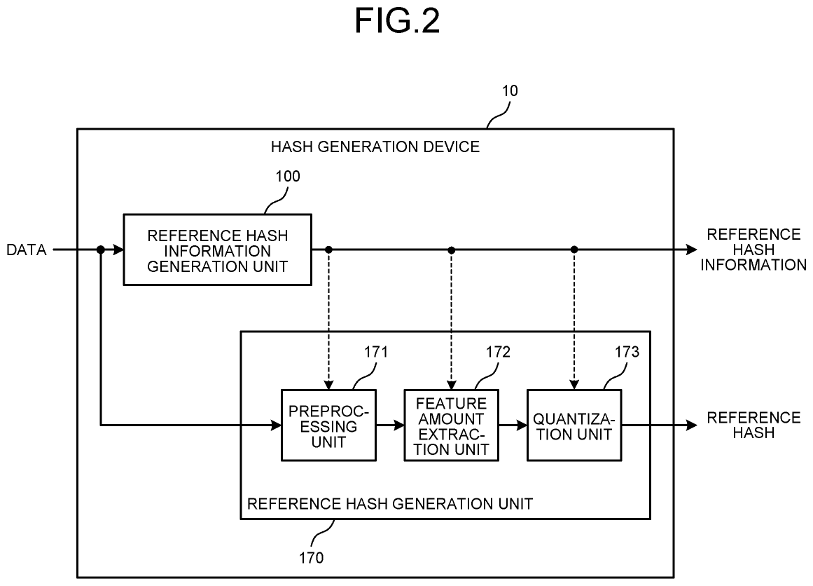

FIG. 2 is a diagram illustrating a basic configuration example of a hash generation device according to the first embodiment of the present disclosure. The drawing is a block diagram illustrating a configuration example of the hash generation device 10. As described above, the hash generation device 10 includes the reference hash information generation unit 100 and the reference hash generation unit 170. The reference hash generation unit 170 in the drawing includes a preprocessing unit 171, a feature amount extraction unit 172, and a quantization unit 173.

The preprocessing unit 171 processes data before extraction processing of a feature amount to be described later. This processing is referred to as preprocessing. The preprocessing unit 171 outputs data after the preprocessing to the feature amount extraction unit 172.

In this preprocessing, processing of adapting a format of multimedia or a size of multimedia, which is data, can be performed. In addition, as the preprocessing, data block division and filter processing can be executed. This block division can apply division of regions along the axis of space or time. Further, the block division may be executed to perform multimedia processing in units of blocks. In addition, the preprocessing unit 171 may determine the size of multimedia to be combined using the reference hash information. For example, the horizontal and vertical sizes of the image can be changed depending on the complexity of the texture in the image. In addition, in the preprocessing unit 171, the number of blocks, the block shape, and the block position can be changed using the reference hash information. For example, the number of blocks to be divided may be changed according to the complexity of the texture in the image. For example, the position of the block to be divided may be changed according to character information, a face, or the like included in the image. In addition, the preprocessing unit 171 can select a coefficient of a filter using the reference hash information. For example, a kernel size and a kernel shape of the filter may be changed according to the complexity of the texture in the image.

The feature amount extraction unit 172 extracts a feature amount of data. Here, the feature amount includes information regarding an outline of a color or a shape of multimedia that is data. The feature amount extraction unit 172 outputs the extracted feature to the quantization unit 173.

As a method of extracting the feature amount, for example, a method by orthogonal transform including discrete cosine transform, discrete Fourier transform, and discrete wavelet transform, a method by projective transform including Radon transform, or a method by dimension reduction including singular value decomposition and non-negative value matrix decomposition can be used. Furthermore, as a method of extracting the feature amount, a method using a statistic including an average or variance histogram, a method using a feature point such as SIFT, or a method based on learning including a deep neural network can be applied.

In addition, the feature amount extraction unit 172 may select the feature amount to be extracted using the reference hash information. Further, the feature amount extraction unit 172 can select a base used for feature amount extraction using the reference hash information. Furthermore, the feature amount extraction unit 172 can also select a direction and a position to be projected using the reference hash information. In addition, the feature amount extraction unit 172 can determine the dimension after the reduction using the reference hash information. Further, the feature amount extraction unit 172 can determine the order of the statistic to be used using the reference hash information. Furthermore, the feature amount extraction unit 172 can determine the number of feature points to be used using the reference hash information. The feature amount extraction unit 172 can also select a data set used for learning using the reference hash information.

The quantization unit 173 performs quantization processing. This quantization processing is processing of reducing the extracted feature amount and outputting the feature amount as the reference hash. The quantization method may be Locality-Sensitive Hashing, rounding of a digit of the feature amount, binarization by a relationship of the feature amount, or binarization by a threshold value of the feature amount. In the quantization processing, the reference hash information can be used to determine a digit of rounding of the quantization. In the quantization processing, the number of feature amounts for which the relationship is determined can be determined using the reference hash information. In the quantization processing, a threshold value for performing binarization may be determined using the reference hash information. In the quantization processing, the data amount can be reduced to be equal to or less than a certain amount using the reference hash information.

### [Basic Configuration of Hash Determination Device]

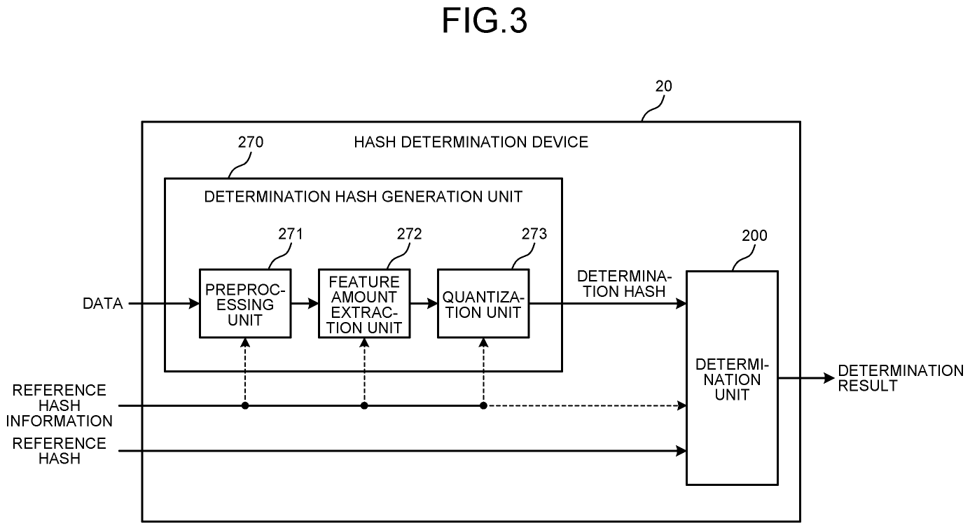

FIG. 3 is a diagram illustrating a basic configuration example of a hash determination device according to the first embodiment of the present disclosure. The drawing is a block diagram illustrating a configuration example of the hash determination device 20. As described above, the hash determination device 20 includes the determination hash generation unit 270 and the determination unit 200.

The determination hash generation unit 270 in the drawing includes a preprocessing unit 271, a feature amount extraction unit 272, and a quantization unit 273. These can be configured similarly to the preprocessing unit 171, the feature amount extraction unit 172, and the quantization unit 173 described in FIG. 2.

The determination unit 200 determines falsification of data on the basis of the determination hash and the reference hash. The determination unit 200 performs determination by comparing the reference hash with the determination hash. This comparison can be performed by determining whether or not the reference hash and the determination hash match. In addition, this comparison can be performed depending on the distance between the reference hash and the determination hash and whether the divergence is equal to or less than a threshold value. A Hamming distance or a Minkowski distance between the hashes can be applied to this distance. In addition, the comparison method can also be performed by determining whether or not the determination hash is included in the region indicated by the reference hash information. Polar coordinates centered on the reference hash can also be used to determine this region. A multi-dimensional voxel can be used to determine this region.

A result of the determination by the determination unit 200 may be whether or not the data and the query data are classified into the same class. Furthermore, the result of the determination may be whether or not the query data is data to which falsification has been added. In addition, the result of the determination can also be indicated by a continuous value such as a ratio.

### [Reference Hash Generation Processing]

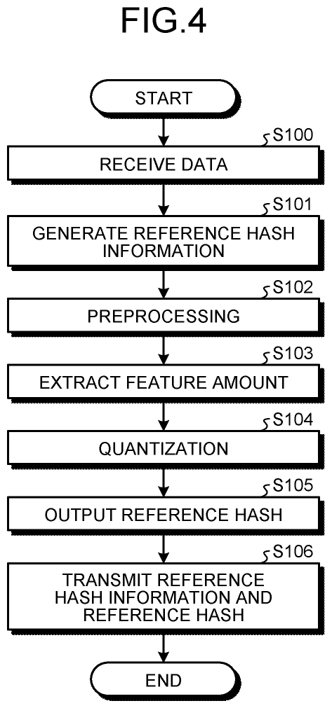

FIG. 4 is a diagram illustrating an example of hash generation processing according to the first embodiment of the present disclosure. The drawing is a flowchart illustrating an example of reference hash generation processing in the hash generation device 10. First, the reference hash generation unit 170 receives data (step S100). Next, the reference hash information generation unit 100 generates the reference hash information (step S101). Next, the preprocessing unit 171 performs preprocessing (step S102). Next, the feature amount extraction unit 172 extracts a feature amount (step S103). Next, the quantization unit 173 performs quantization (step S104). The reference hash generation unit 170 outputs the generated reference hash (step S105). Next, the hash generation device 10 transmits the generated reference hash information and reference hash (step S106).

### [Hash Determination Processing]

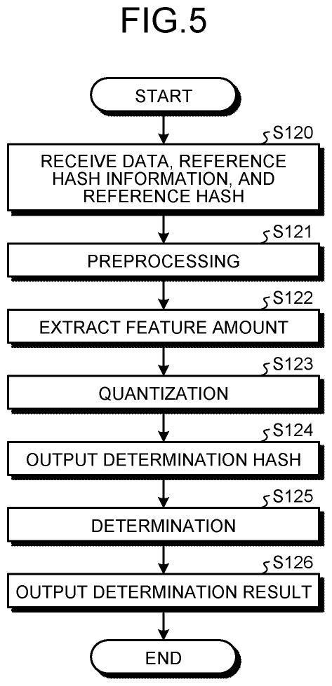

FIG. 5 is a diagram illustrating an example of hash determination processing according to the first embodiment of the present disclosure. The drawing is a flowchart illustrating an example of hash determination processing in the hash determination device 20. First, the hash determination device 20 receives the data, the reference hash information, and the reference hash (step S120). Next, the preprocessing unit 271 performs preprocessing (step S121). Next, the feature amount extraction unit 272 extracts a feature amount (step S122). Next, the quantization unit 273 performs quantization (step S123). The determination hash generation unit 270 outputs the generated determination hash (step S124). Next, the determination unit 200 makes a determination (step S125). Thereafter, the hash determination device 20 outputs a determination result (step S126).

As described above, the system of the embodiment of the present disclosure generates the reference hash using the reference hash information having two or more dimensions in association with each other, and uses the generated reference hash for determination of falsification. By using information in which two or more pieces of information associated with each other are combined, it is possible to improve detection capability of falsification while preventing complication of processing.

### 2. Second Embodiment

In a second embodiment of the present disclosure, a case where filter processing is performed in the reference hash information generation unit 100 will be described.

### [Configuration of Hash Generation Device]

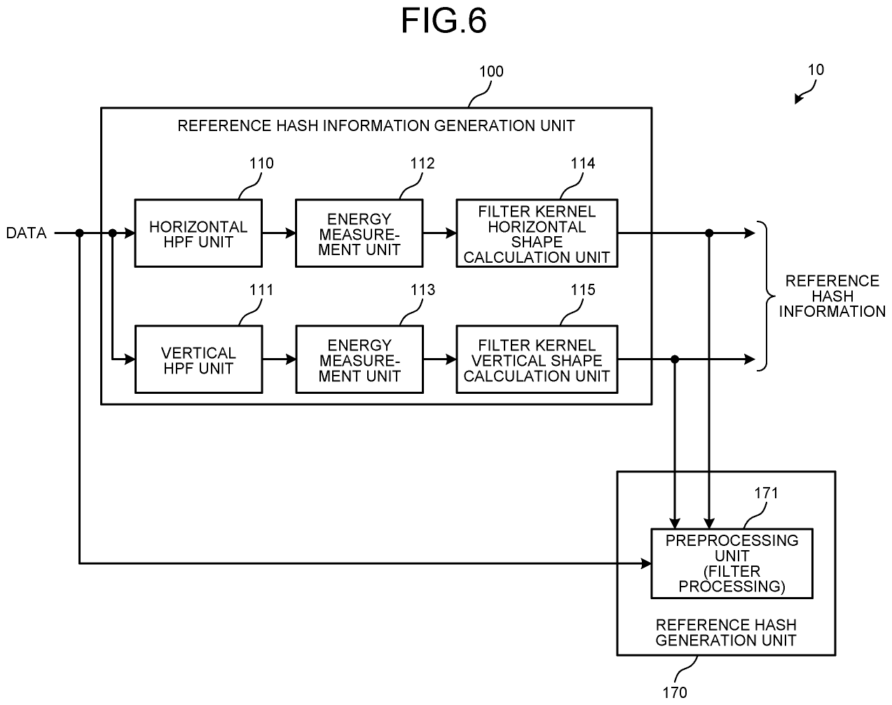

FIG. 6 is a diagram illustrating a configuration example of a hash generation device according to the second embodiment of the present disclosure. The drawing is a block diagram illustrating a configuration example of the hash generation device 10. The reference hash information generation unit 100 in the drawing includes a horizontal HPF unit 110, a vertical HPF unit 111, energy measurement units 112 and 113, a filter kernel horizontal shape calculation unit 114, and a filter kernel vertical shape calculation unit 115.

The horizontal HPF unit 110 performs high-pass filter processing on data in a horizontal direction, that is, in an x-axis direction.

The vertical HPF unit 111 performs high-pass filter processing on data in a vertical direction, that is, a y-axis direction.

The energy measurement units 112 and 113 measure energy in the horizontal direction and the vertical direction of data, respectively. This measurement of energy can be performed by a sum of absolute values or a sum of squares of pixel values of an image of data.

The filter kernel horizontal shape calculation unit 114 and the filter kernel vertical shape calculation unit 115 calculate the shapes of the filter kernels in the horizontal direction and the vertical direction, respectively. By measuring energy in the horizontal direction and the vertical direction, complexity in the horizontal direction and the vertical direction of data such as an image is detected. The shape of the filter kernel is calculated according to the detected complexity. The calculated shapes of the plurality of filter kernels are output as the reference hash information.

The preprocessing unit 171 performs filter processing as preprocessing. Low-pass filter processing can be applied to this filter processing.

### [Shape of Filter Kernel]

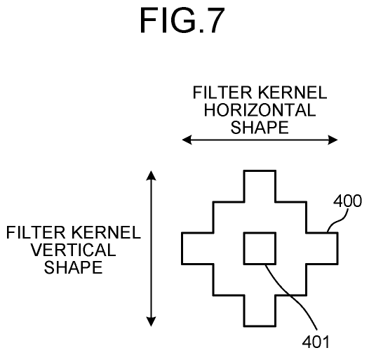

FIG. 7 is a diagram illustrating an example of a shape of a filter kernel according to the second embodiment of the present disclosure. The drawing illustrates a filter kernel 400 for image data of a pixel 401.

The configuration of the system 1 other than this is similar to the configuration of the system 1 in the first embodiment of the present disclosure, and thus description thereof is omitted.

### 3. Third Embodiment

In a third embodiment of the present disclosure, a case where processing of changing the image size is performed in the reference hash information generation unit 100 will be described.

### [Configuration of Hash Generation Device]

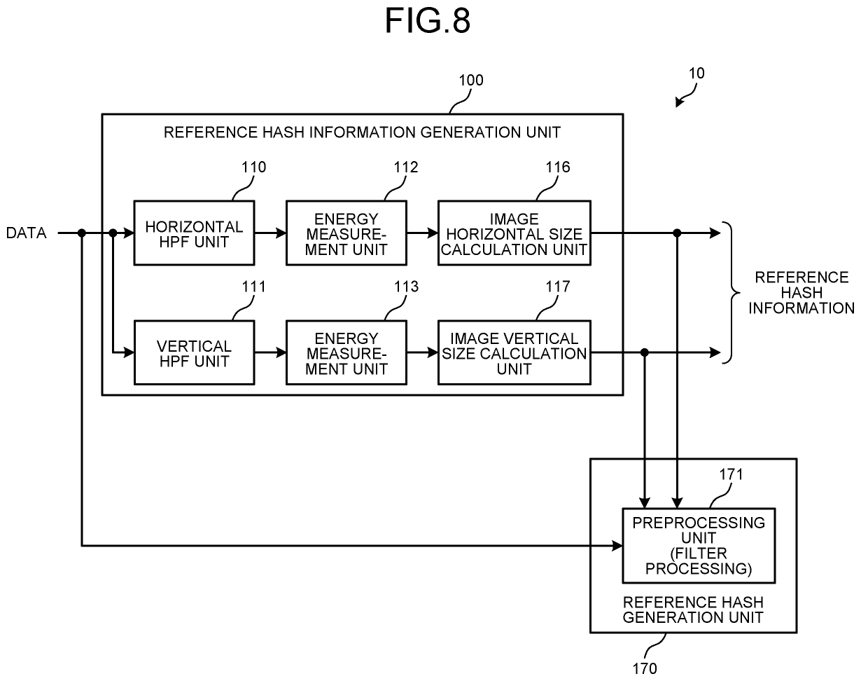

FIG. 8 is a diagram illustrating a configuration example of a hash generation device according to the third embodiment of the present disclosure. The drawing is a block diagram illustrating a configuration example of the hash generation device 10. The reference hash information generation unit 100 in the drawing includes the horizontal HPF unit 110, the vertical HPF unit 111, the energy measurement units 112 and 113, an image horizontal size calculation unit 116, and an image vertical size calculation unit 117.

The image horizontal size calculation unit 116 and the image vertical size calculation unit 117 calculate the sizes of images in the horizontal direction and the vertical direction, respectively. By measuring energy in the horizontal direction and the vertical direction, image sizes in the horizontal direction and the vertical direction of data such as an image are calculated. The calculated image sizes in the horizontal and vertical directions are output as the reference hash information.

The preprocessing unit 171 in the drawing performs image reduction processing as preprocessing.

The configuration of the system 1 other than this is similar to the configuration of the system 1 in the second embodiment of the present disclosure, and thus description thereof is omitted.

### 4. Fourth Embodiment

In a fourth embodiment of the present disclosure, a case where processing of dividing an image into blocks is performed in the reference hash information generation unit 100 will be described.

### [Configuration of Hash Generation Device]

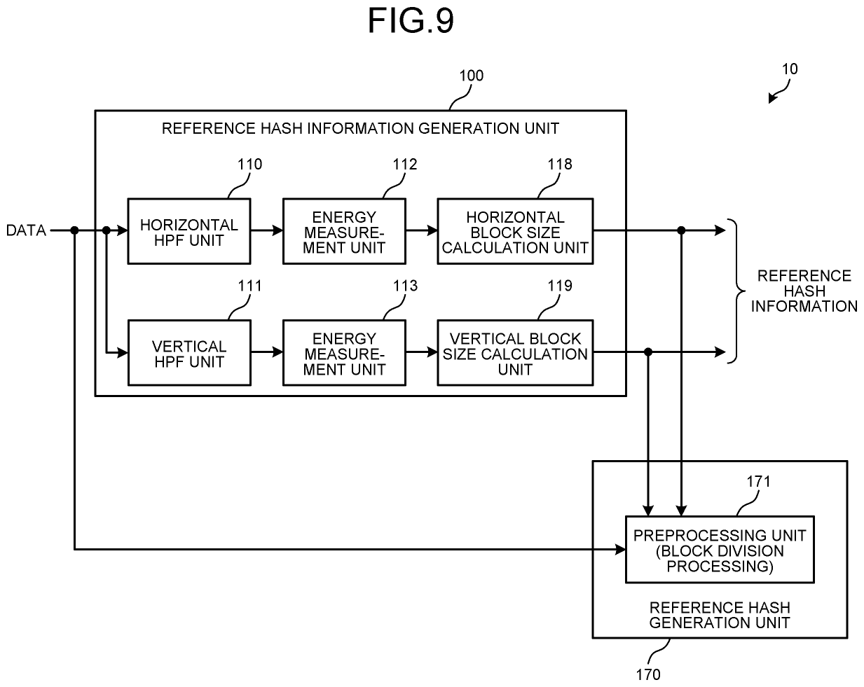

FIG. 9 is a diagram illustrating a configuration example of a hash generation device according to the fourth embodiment of the present disclosure. The drawing is a block diagram illustrating a configuration example of the hash generation device 10. The reference hash information generation unit 100 in the drawing includes the horizontal HPF unit 110, the vertical HPF unit 111, the energy measurement units 112 and 113, a horizontal block size calculation unit 118, and a vertical block size calculation unit 119.

The horizontal block size calculation unit 118 and the vertical block size calculation unit 119 calculate the sizes of blocks to be divided in the horizontal direction and the vertical direction, respectively. By measuring energy in the horizontal direction and the vertical direction, the sizes of the block divided in the horizontal direction and the vertical direction of data such as an image are calculated. The calculated sizes of the block in the horizontal and vertical directions are output as the reference hash information.

The preprocessing unit 171 performs block division processing as preprocessing.

### [Another Configuration of Hash Generation Device]

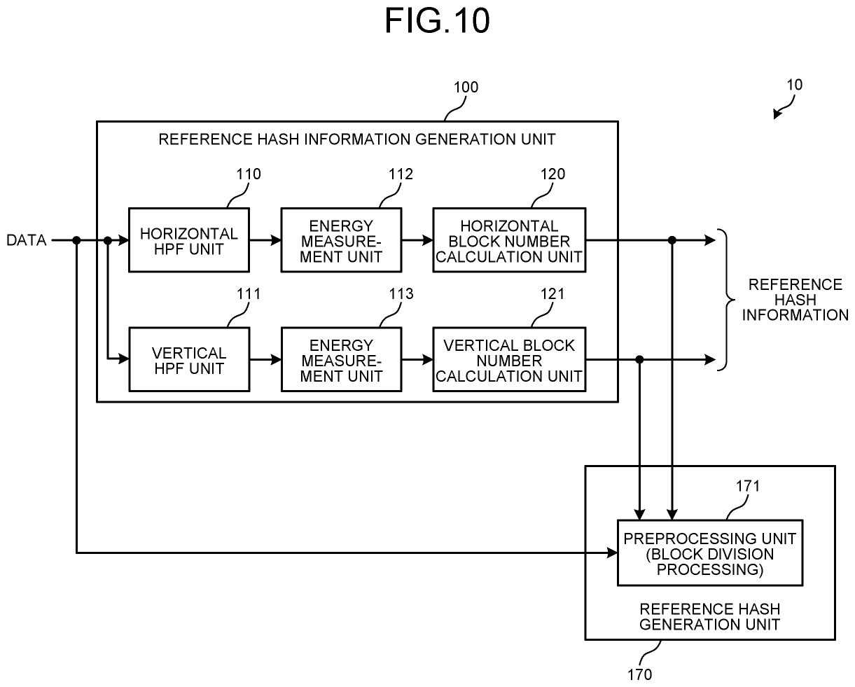

FIG. 10 is a diagram illustrating another configuration example of the hash generation device according to the fourth embodiment of the present disclosure. The drawing is a block diagram illustrating a configuration example of the hash generation device 10. The reference hash information generation unit 100 in the drawing includes the horizontal HPF unit 110, the vertical HPF unit 111, the energy measurement units 112 and 113, a horizontal block number calculation unit 120, and a vertical block number calculation unit 121.

The horizontal block number calculation unit 120 and the vertical block number calculation unit 121 calculate the number of blocks to be divided in the horizontal direction and the vertical direction, respectively. By measuring energy in the horizontal direction and the vertical direction, the number of blocks into which data such as an image is divided in the horizontal direction and the vertical direction is calculated. The calculated numbers of blocks in the horizontal and vertical directions are output as the reference hash information.

### [Shape of Block]

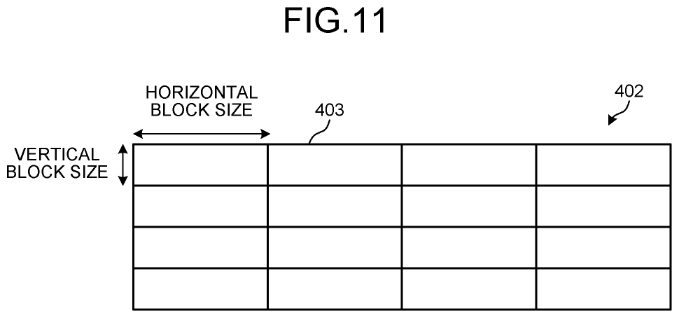

FIG. 11 is a diagram illustrating an example of a shape of a block according to the fourth embodiment of the present disclosure. This drawing illustrates blocks 403 that divide data 402 such as an image. The drawing illustrates an example of a case where the data 402 is divided into four in the horizontal direction and the vertical direction.

### 5. Fifth Embodiment

In a fifth embodiment of the present disclosure, a case where processing of detecting a character of data or a face of a person is performed in the reference hash information generation unit 100 will be described.

### [Configuration of Hash Generation Device]

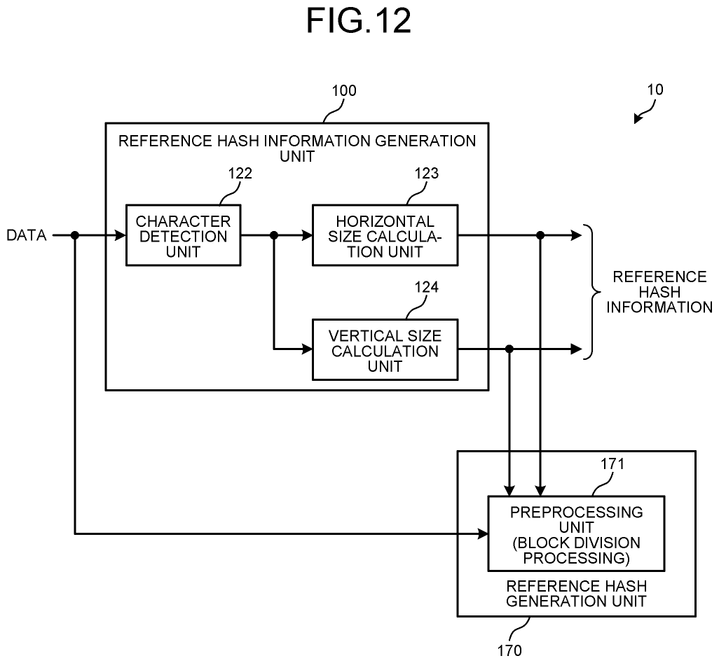

FIG. 12 is a diagram illustrating a configuration example of a hash generation device according to the fifth embodiment of the present disclosure. The drawing is a block diagram illustrating a configuration example of the hash generation device 10. The reference hash information generation unit 100 in the drawing includes a character detection unit 122, a horizontal size calculation unit 123, and a vertical size calculation unit 124.

The character detection unit 122 detects a character portion of data. The horizontal size calculation unit 123 and the vertical size calculation unit 124 calculate the sizes of character regions to be divided in the horizontal direction and the vertical direction, respectively. The calculated sizes of the character regions in the horizontal and vertical directions are output as the reference hash information. Note that the character detection unit 122 can also employ a configuration of detecting a face portion of a person in data.

The preprocessing unit 171 performs block division processing as preprocessing.

### [Shape of Block]

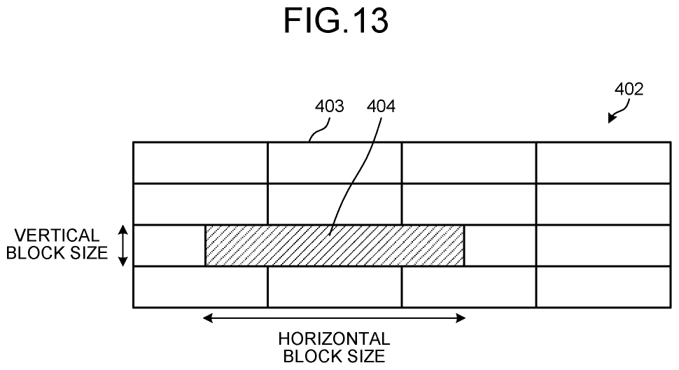

FIG. 13 is a diagram illustrating an example of a shape of a block according to the fifth embodiment of the present disclosure. The drawing illustrates a size of a block of a character portion. A hatched region in the drawing represents a block 404 of a character portion. In this manner, the block 404 of the character portion can be divided into different sizes from other blocks.

The configuration of the system 1 other than this is similar to the configuration of the system 1 in the first embodiment of the present disclosure, and thus description thereof is omitted.

### 6. Sixth Embodiment

In a sixth embodiment of the present disclosure, a case of extracting a feature amount based on a base will be described.

### [Configuration of Hash Generation Device]

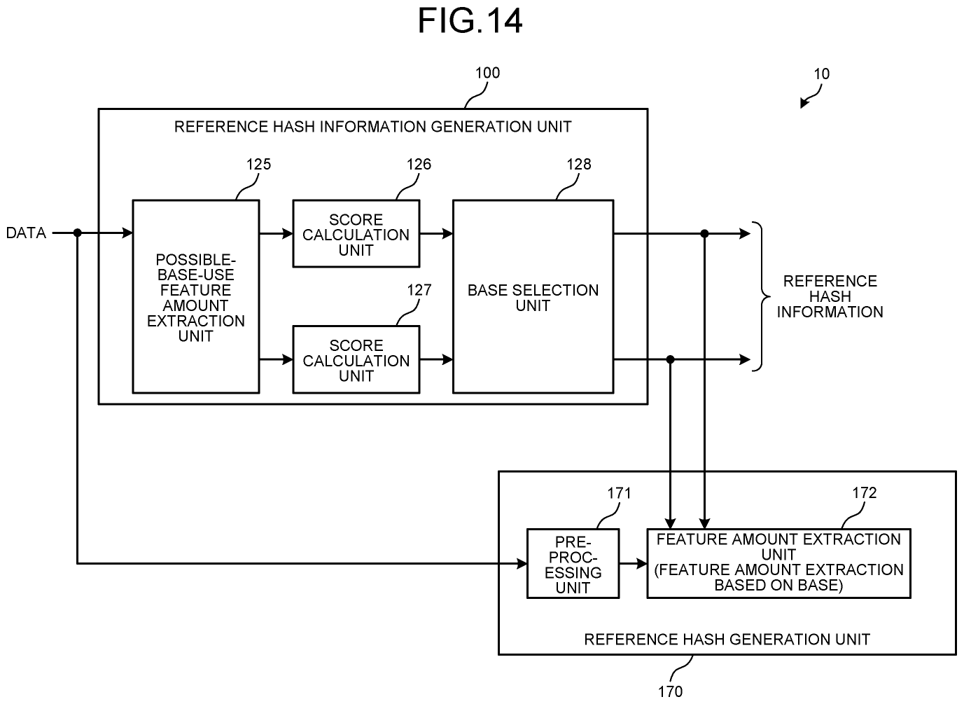

FIG. 14 is a diagram illustrating a configuration example of a hash generation device according to the sixth embodiment of the present disclosure. The drawing is a block diagram illustrating a configuration example of the hash generation device 10. The reference hash information generation unit 100 in the drawing includes a possible-base-use feature amount extraction unit 125, score calculation units 126 and 127, and a base selection unit 128.

The possible-base-use feature amount extraction unit 125 extracts a feature amount using a plurality of possible bases determined in advance. The possible-base-use feature amount extraction unit 125 extracts a feature amount for each possible base.

The score calculation units 126 and 127 calculate scores. The score calculation unit 126 and the like are arranged for each possible base of the possible-base-use feature amount extraction unit 125, and calculate a score for each possible base. The score can be calculated by calculating an absolute value with respect to the feature amount.

The base selection unit 128 selects a base from possible bases on the basis of the score from the score calculation unit 126 and the like. This selection can be performed by ranking according to the score. By this ranking, a plurality of bases having high priority is selected and output as the reference hash information.

Note that the hash generation device 10 in the drawing represents a case where there are two pieces of reference hash information, but three or more pieces of reference hash information can be used. In this case, it is possible to employ a configuration in which the score calculation unit is arranged for each piece of reference hash information.

The feature amount extraction unit 172 in the drawing performs processing of extracting a feature amount based on the base.

The configuration of the system 1 other than this is similar to the configuration of the system 1 in the first embodiment of the present disclosure, and thus description thereof is omitted.

### 7. Seventh Embodiment

In a seventh embodiment of the present disclosure, a case where projection processing is performed with the center of a character or a face portion of a person as a projection center will be described.

### [Configuration of Hash Generation Device]

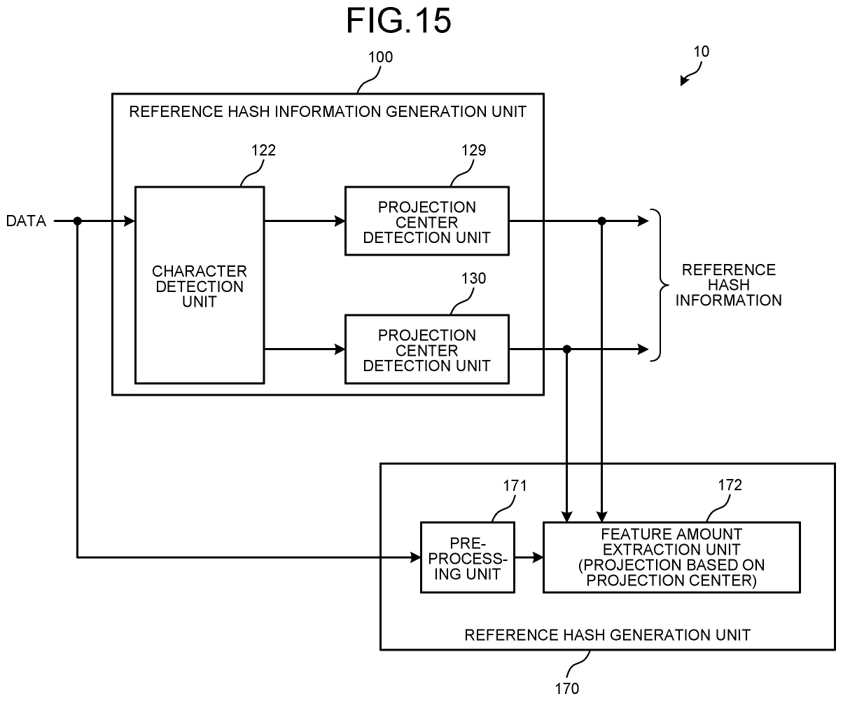

FIG. 15 is a diagram illustrating a configuration example of a hash generation device according to the seventh embodiment of the present disclosure. The drawing is a block diagram illustrating a configuration example of the hash generation device 10. The reference hash information generation unit 100 in the drawing includes the character detection unit 122 and projection center detection units 129 and 130.

The character detection unit 122 in the drawing detects regions of a plurality of characters. Note that the character detection unit 122 can also employ a configuration of detecting a face portion of a person in data.

The projection center detection units 129 and 130 detect the center of a region of a character detected by the character detection unit 122 and output the center as a projection center. The projection center detection unit 129 and the like are arranged for each character detected by the character detection unit 122 and detect a projection center. A plurality of detected projection centers is output as the reference hash information.

Note that the hash generation device 10 in the drawing represents a case where there are two pieces of reference hash information, but three or more pieces of reference hash information can be used. In this case, it is possible to employ a configuration in which the projection center detection unit is arranged for each piece of reference hash information.

The feature amount extraction unit 172 in the drawing extracts a feature amount by performing processing of projection based on the projection center.

### [Projection Center]

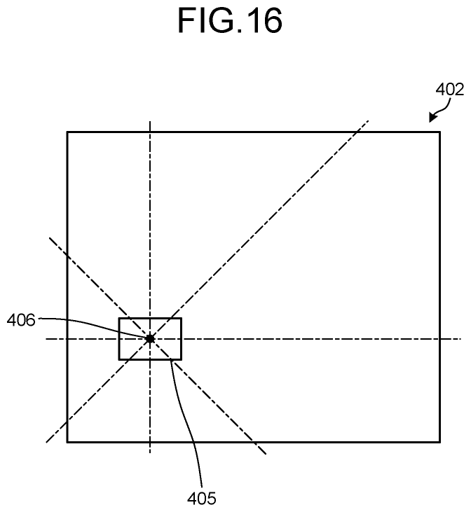

FIG. 16 is a diagram illustrating an example of the projection center according to the seventh embodiment of the present disclosure. The drawing illustrates an example in a case where a center 406 of a block 405 of the character portion of the data 402 is set as the projection center. A one dot chain line in the drawing represents a projection direction passing through the center 406.

The configuration of the system 1 other than this is similar to the configuration of the system 1 in the first embodiment of the present disclosure, and thus description thereof is omitted.

### 8. Eighth Embodiment

In an eighth embodiment of the present disclosure, a case where rounding processing in quantization is performed will be described.

### [Configuration of Hash Generation Device]

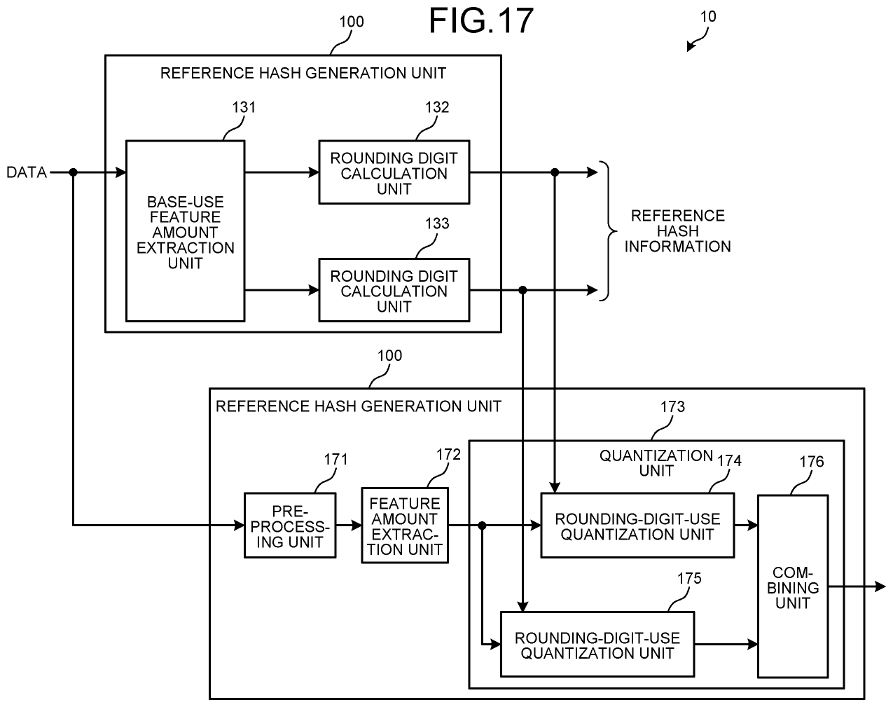

FIG. 17 is a diagram illustrating a configuration example of a hash generation device according to the eighth embodiment of the present disclosure. The drawing is a block diagram illustrating a configuration example of the hash generation device 10. The reference hash information generation unit 100 in the drawing includes a base-use feature amount extraction unit 131 and rounding digit calculation units 132 and 133.

The base-use feature amount extraction unit 131 extracts a feature amount using a base.

The rounding digit calculation units 132 and 133 calculate rounding digits for the feature amount extracted by the base-use feature amount extraction unit 131. The rounding digit calculation unit 132 and the like are arranged for each feature amount extracted by the base-use feature amount extraction unit 131 and calculate each rounding digit. A plurality of calculated rounding digits is output as the reference hash information.

Note that the hash generation device 10 in the drawing represents a case where there are two pieces of reference hash information, but three or more pieces of reference hash information can be used. In this case, it is possible to employ a configuration in which the rounding digit calculation unit is arranged for each piece of reference hash information. Also in the quantization unit 173, three or more rounding-digit-use quantization units are arranged according to the number of pieces of reference hash information.

The quantization unit 173 in the drawing includes rounding-digit-use quantization units 174 and 175 and a combining unit 176. The rounding-digit-use quantization units 174 and 175 perform rounding processing on the basis of the input number of rounding digits. The combining unit 176 combines the outputs of the rounding-digit-use quantization units 174 and 175.

The configuration of the system 1 other than this is similar to the configuration of the system 1 in the first embodiment of the present disclosure, and thus description thereof is omitted.

### 9. Ninth Embodiment

In a ninth embodiment of the present disclosure, a case where the number of feature amounts is compared will be described.

### [Configuration of Hash Generation Device]

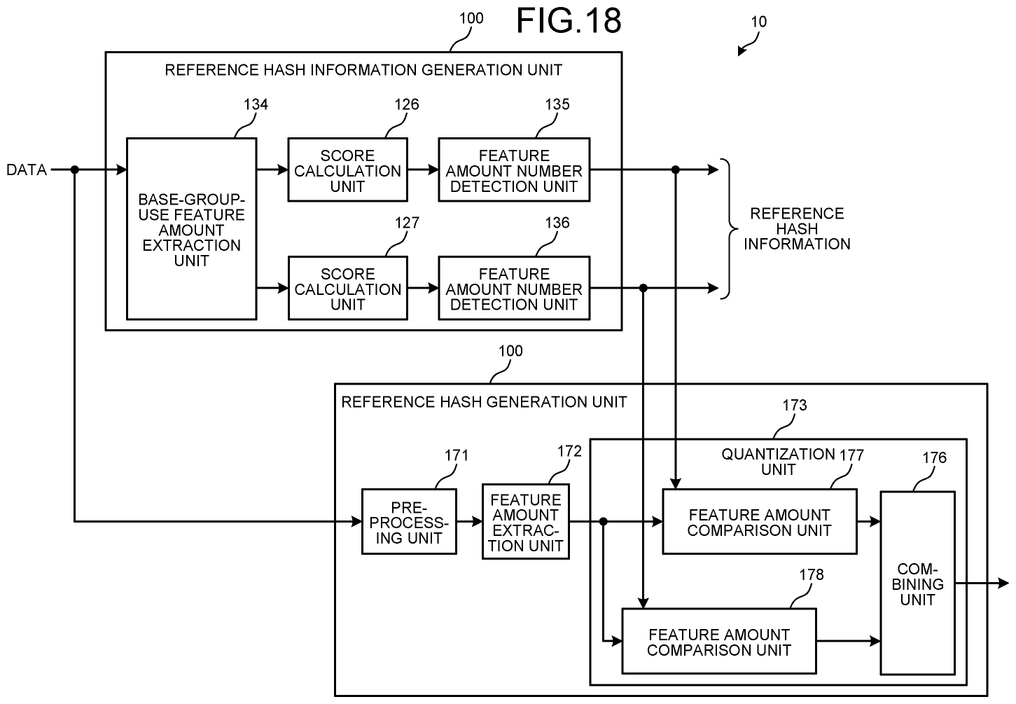

FIG. 18 is a diagram illustrating a configuration example of a hash generation device according to the ninth embodiment of the present disclosure. The drawing is a block diagram illustrating a configuration example of the hash generation device 10. The reference hash information generation unit 100 in the drawing includes a base-group-use feature amount extraction unit 134, the score calculation units 126 and 127, and feature amount number detection units 135 and 136.

The base-group-use feature amount extraction unit 134 extracts a feature amount using a base group that is a group of bases. The base-group-use feature amount extraction unit 134 extracts a feature amount for each base group.

The score calculation units 126 and 127 in the drawing calculate scores for each base group in the base-group-use feature amount extraction unit 134.

The feature amount number detection units 135 and 136 detect the number of feature amounts for each group on the basis of the score for each base group in the base-group-use feature amount extraction unit 134. A plurality of the detected numbers of feature amounts is output as the reference hash information.

Note that the hash generation device 10 in the drawing represents a case where there are two pieces of reference hash information, but three or more pieces of reference hash information can be used. In this case, it is possible to employ a configuration in which a score calculation unit and a feature amount number detection unit are arranged for each piece of reference hash information. Also in the quantization unit 173, three or more feature amount comparison units are arranged according to the number of pieces of reference hash information.

The quantization unit 173 in the drawing includes feature amount comparison units 177 and 178 and the combining unit 176. The feature amount comparison units 177 and 178 determine, for each group, a feature amount corresponding to the number of input feature amounts for each group, and generate a hash by comparing a relationship of the feature amounts in the group. The combining unit 176 in the drawing couples the outputs of the feature amount comparison units 177 and 178.

### [Number of Feature Amounts]

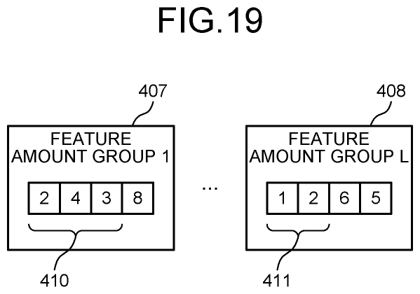

FIG. 19 is a diagram illustrating an example of the numbers of feature amounts of feature amount groups according to the ninth embodiment of the present disclosure. This drawing illustrates an example of the numbers of feature amounts of feature amount groups 407 and 408. The feature amount groups 407 and 408 represent the first and the L-th feature amount groups, respectively. Rectangles in the feature amount groups 407 and 408 represent the numbers 410 and 411 of feature amounts. As the numbers of feature amounts, the numbers of feature amounts that are not the same out of the feature amount groups 407 and 408 are used.

The configuration of the system 1 other than this is similar to the configuration of the system 1 in the first embodiment of the present disclosure, and thus description thereof is omitted.

### 10. Tenth Embodiment

In a tenth embodiment of the present disclosure, a case where quantization is performed by binarization using a threshold value will be described.

### [Configuration of Hash Generation Device]

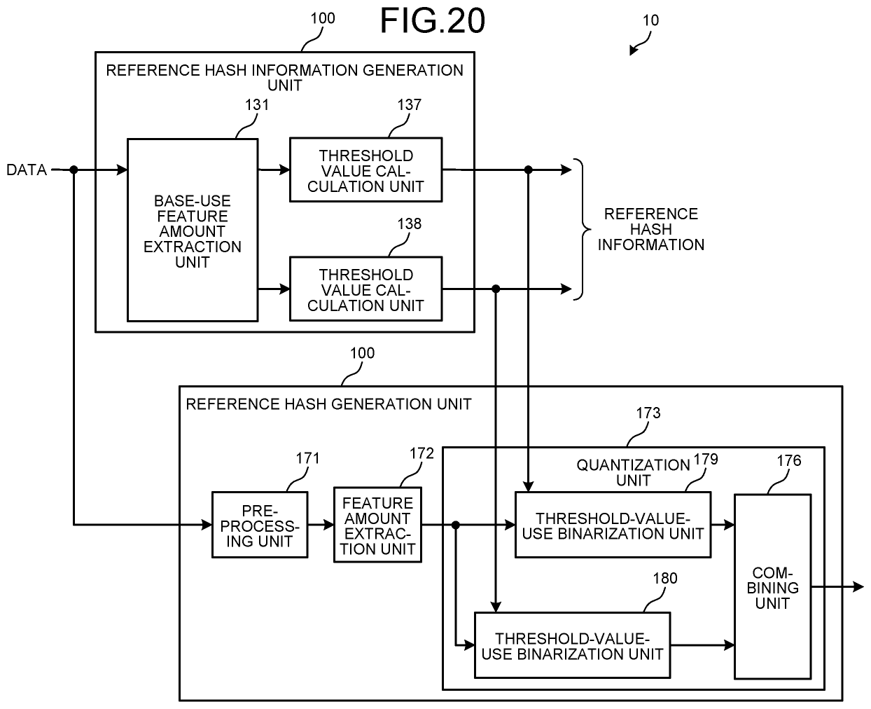

FIG. 20 is a diagram illustrating a configuration example of a hash generation device according to a tenth embodiment of the present disclosure. The drawing is a block diagram illustrating a configuration example of the hash generation device 10. The reference hash information generation unit 100 in the drawing includes the base-use feature amount extraction unit 131 and threshold value calculation units 137 and 138.

The threshold value calculation units 137 and 138 calculate a threshold value for binarizing the feature amount extracted by the base-use feature amount extraction unit 131. The plurality of calculated threshold values is output as the reference hash information.

Note that the hash generation device 10 in the drawing represents a case where there are two pieces of reference hash information, but three or more pieces of reference hash information can be used. In this case, it is possible to employ a configuration in which the threshold value calculation unit is arranged for each piece of reference hash information. Also in the quantization unit 173, three or more threshold-value-use binarization units are arranged according to the number of pieces of reference hash information.

The quantization unit 173 in the drawing includes threshold-value-use binarization units 179 and 180 and the combining unit 176. The threshold-value-use binarization units 179 and 180 binarize the feature amount using the input threshold value. The combining unit 176 in the drawing combines the outputs of the threshold-value-use binarization units 179 and 180.

The configuration of the system 1 other than this is similar to the configuration of the system 1 in the first embodiment of the present disclosure, and thus description thereof is omitted.

### 11. Eleventh Embodiment

In an eleventh embodiment of the present disclosure, a case where a hash region including a plurality of hashes is generated as the reference hash information will be described.

### [Configuration of Hash Generation Device]

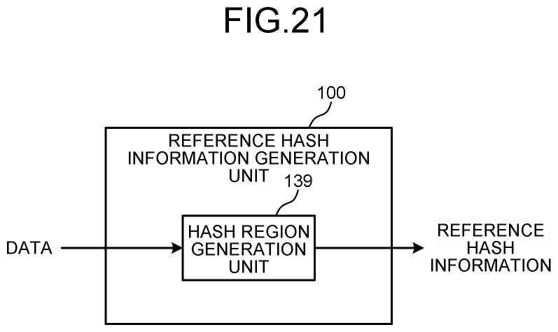

FIG. 21 is a diagram illustrating a schematic configuration example of a hash generation device according to the eleventh embodiment of the present disclosure. The drawing is a block diagram illustrating a configuration example of the hash generation device 10. The reference hash information generation unit 100 in the drawing includes a hash region generation unit 139.

The hash region generation unit 139 generates a hash region that is a region including a plurality of hashes. The generated hash region is output as the reference hash information.

The configuration of the system 1 other than this is similar to the configuration of the system 1 in the first embodiment of the present disclosure, and thus description thereof is omitted.

### 12. Twelfth Embodiment

In a twelfth embodiment of the present disclosure, a specific example of generating a hash region including a plurality of hashes will be described.

### [Configuration of Hash Generation Device]

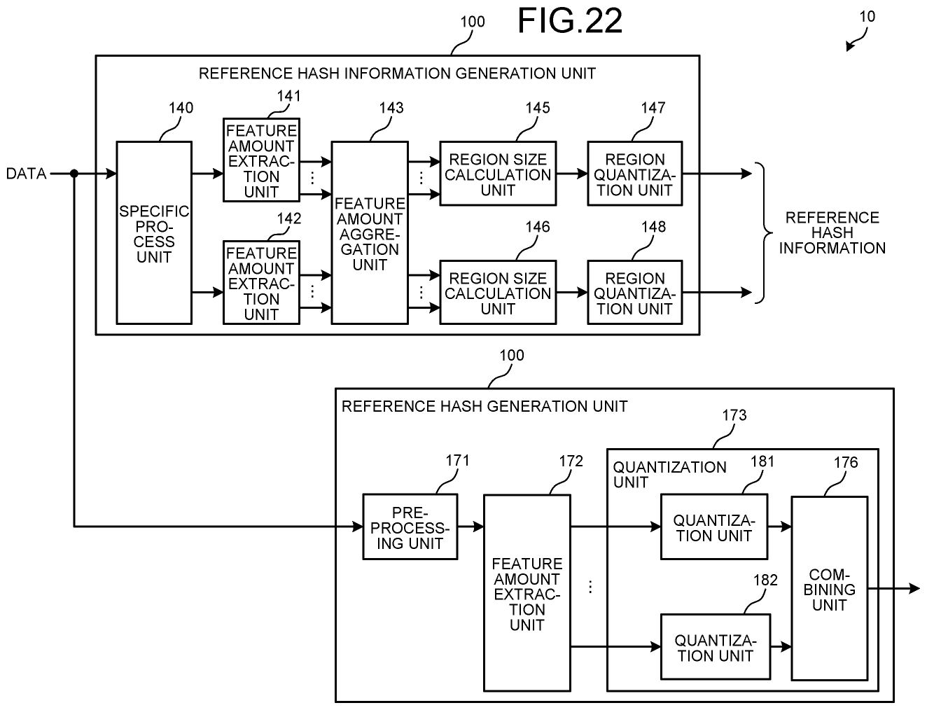

FIG. 22 is a diagram illustrating a configuration example of a hash generation device according to the twelfth embodiment of the present disclosure. The drawing is a block diagram illustrating a configuration example of the hash generation device 10. The reference hash information generation unit 100 in the drawing includes a specific process unit 140, feature amount extraction units 141 and 142, a feature amount aggregation unit 143, region size calculation units 145 and 146, and region quantization units 147 and 148.

The specific process unit 140 performs a plurality of predetermined specific processes on the data. The specific process unit 140 outputs data after each of the specific processes.

The feature amount extraction units 141 and 142 extract feature amounts. The feature amount extraction unit 141 and the like are arranged for each specific process from the specific process unit 140 and extract a feature amount for each data after the specific process.

The feature amount aggregation unit 143 aggregates and summarizes a plurality of feature amounts extracted by the feature amount extraction unit 141 and the like for each specific process of the specific process unit 140.

The region size calculation units 145 and 146 calculate the sizes of regions of a plurality of feature amounts. The region size calculation unit 145 and the like calculate the sizes of the regions aggregated by the feature amount aggregation unit 143. The size can be calculated by a range between a maximum value and a minimum value.

The region quantization units 147 and 148 perform quantization on the basis of the sizes of the regions calculated by the region size calculation units 145 and 146. The sizes of the plurality of quantized regions represent hash regions, and are output as the reference hash information.

Note that the hash generation device 10 in the drawing represents a case where there are two pieces of reference hash information, but three or more pieces of reference hash information can be used. In this case, it is possible to employ a configuration in which a feature amount extraction unit, a region size calculation unit, and a region quantization unit are arranged for each piece of reference hash information. Also in the quantization unit 173, three or more quantization units are arranged according to the number of pieces of reference hash information.

The quantization unit 173 in the drawing includes quantization units 181 and 182 and the combining unit 176. The quantization units 181 and 182 quantize respective feature amounts output from the feature amount extraction unit 172. The combining unit 176 in the drawing combines the outputs of the quantization units 181 and 182.

### [Hash Region]

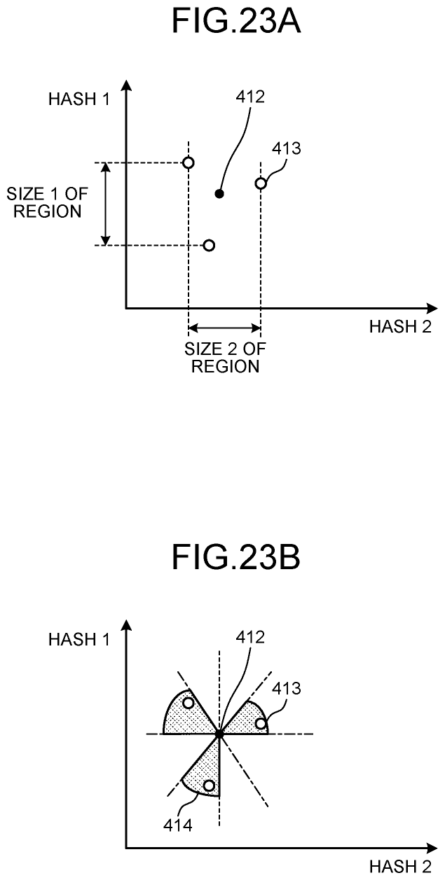

FIG. 23A is a diagram illustrating an example of a hash region according to the twelfth embodiment of the present disclosure. In the drawing, a plurality of hashes is numbered like a hash 1 and a hash 2, and each hash is represented as an axis of a hash space. The size of the region can be indicated by a distance with a reference sign of projection of a maximum value and a minimum value of the projection of the reference hash by projecting the reference hash and a hash in a case where the predetermined specific process is applied to the data on one axis. A black circle in the drawing represents a reference hash 412. Furthermore, a white circle in the drawing represents a hash 413 in a case where a predetermined specific process is applied. The hash region is a multi-dimensional cuboid (two-dimensional in the example of the drawing).

The determination in the determination unit 200 can be performed by expressing the region using the reference hash and the size of the region corresponding to all the axes and determining whether the determination hash is included in the region.

### [Another Example of Hash Region]

FIG. 23B is a diagram illustrating another example of the hash region according to the twelfth embodiment of the present disclosure. This drawing illustrates an example of a case where the hash region is represented by polar coordinates centered on the reference hash.

### [Configuration of Hash Determination Device]

FIG. 24 is a diagram illustrating a configuration example of a hash determination device according to the twelfth embodiment of the present disclosure. The drawing is a block diagram illustrating a configuration example of the hash determination device 20. The determination unit 200 in the drawing includes decomposition units 201 and 205, region-use determination units 202 and 203, and a comprehensive determination unit 204.

The decomposition unit 201 decomposes the determination hash combined by the quantization unit 273. In addition, the decomposition unit 205 decomposes the reference hash similarly to the determination hash.

The region-use determination units 202 and 203 determine whether or not the determination hash is included in the hash region included in the reference hash information.

The comprehensive determination unit 204 makes a determination on the basis of determination results of the region-use determination units 202 and 203.

Note that the hash determination device 20 represents a case where there are two pieces of reference hash information, but three or more pieces of reference hash information can be used. In this case, it is possible to employ a configuration in which the region-use determination unit is arranged for each piece of reference hash information. Also in the quantization unit 173, three or more quantization units are arranged according to the number of pieces of reference hash information.

### Numerical Example 1

A numerical example in a case where falsification of data is detected using the hash generation device 10 and the hash determination device 20 according to the twelfth embodiment of the present disclosure will be described. An image is used as data.

First, a low-pass filter is applied in the preprocessing unit 171 in FIG. 22 to perform processing of reducing to 128 pixels×128 pixels. Next, the feature amount extraction unit 172 performs learned quaternion discrete Fourier transform. Assuming that R, G, and B channels of a color image are r(x, y), g(x, y), and b(x, y), the following expression is calculated from the quaternion expression I (x, y)=ir (x, y)+jg (x, y)+kb (x, y) of a color image.

$$Q ( u , v ) = \frac{1}{128} {\sum }_{x = 0}^{127} {\sum }_{y = 0}^{127} {e}^{- \frac{2 π}{\sqrt{3}} ( i + j + k ) \frac{ux + vy}{128}} I ( x , y ) \qquad ( 1 )$$

Among these Q(u, v), 256 pieces satisfying u≤15 and v≤15 are selected. Coefficients corresponding to the quaternion units 1, i, j, and k are extracted, and all 1024 coefficients are arranged as a vector f. Next, 120 coefficients out of the 1024 coefficients are extracted by learning. A set of predetermined process P_{gen} is applied to 55 images to create a data set T. Further, it is assumed that an m-th image is Iₘ. It is assumed that, among T, one generated from Iₘ is Sₘ, and the others are Dₘ. For the image I, a mapping that generates an i-th element of f is set as Hᵢ. At this time, a True Positive Rate (TPR) and a False Positive Rate (FPR) are defined as follows.

$$T P {R}_{i m} ( {τ}_{+} , {τ}_{-} ) := \vert \{ I \vert I ∈ {S}_{m} , {τ}_{-} \leq {H}_{i} ( I ) \leq {τ}_{+} \} \vert / \vert {S}_{m} \vert$$

$$FP {R}_{i m} ( {τ}_{+} , {τ}_{-} ) := \vert \{ I \vert I ∈ {D}_{m} , {τ}_{-} \leq {H}_{i} ( I ) \leq {τ}_{+} \} \vert / \vert {D}_{m} \vert$$

Here, τ₊ and τ₋ are threshold values. The score is calculated by using the following formula, and the 120 coefficients are extracted by using the indexes corresponding to the largest 120 scores.

$${min}_{m} {max}_{{τ}_{+} , {τ}_{-}} \frac{2 \cdot {TPR}_{im} ( {τ}_{+} , {τ}_{-} ) \cdot ( 1 - {FPR}_{im} ( {τ}_{+} , {τ}_{-} ) )}{{TPR}_{im} ( {τ}_{+} , {τ}_{-} ) + ( 1 - {FPR}_{im} ( {τ}_{+} , {τ}_{-} ) )} \qquad ( 2 )$$

The quantization units 181 and 182 perform quantization using 64-bit floating point decimal.

As the process P_{gen} executed by the specific process unit 140, 81 types of processes in which JPEG compression and reduction and JPEG compression and reduction are combined are each executed with different parameters. The feature amount extraction units 141 and 142 execute the processes of the preprocessing unit 171 and the feature amount extraction unit 172, respectively. In the region size calculation units 145 and 146, the size of the region is indicated by a distance with a reference sign of projection of a maximum value and a minimum value of the projection of the reference hash by projecting the reference hash and a hash in a case where the predetermined specific process is applied to the data on one axis. The region quantization units 147 and 148 execute the processing of the quantization units 181 and 182.

The region-use determinations 202 and 203 of FIG. 24 make a determination based on whether the projection of the determination hash is included between a maximum value and a minimum value.

### [Effects]

The effect of the technology of the present disclosure will be described using an evaluation data set. In this evaluation data set, there are 50 images with falsification and 50 images without falsification. The size of the region of the falsified image of this evaluation data set is approximately 0.1% with respect to the entire image. In the evaluation data set, there is a variation in which the above predetermined 81 processes P_{gen} are applied to each image.

For the present invention, the method in the article of ‘An Image Hashing Algorithm for Authentication with Multi-Attack Reference Generation and Adaptive Thresholding’ [http://dx.doi.org/10.3390/a13090227] is used as a comparison method. In the preprocessing of the comparison method, similarly to the condition of the present invention, processing of applying a low-pass filter and reducing to 128 pixels×128 pixels is performed. The feature amount extraction uses quaternion discrete Fourier transform, and a 120-dimensional hash is obtained using semi-supervised learning in the paper among coefficients satisfying u≤15 and v≤15. Quantization using 64-bit floating point decimal is used as the quantization. In the determination, adaptive one-dimensional threshold value calculation in the paper is used.

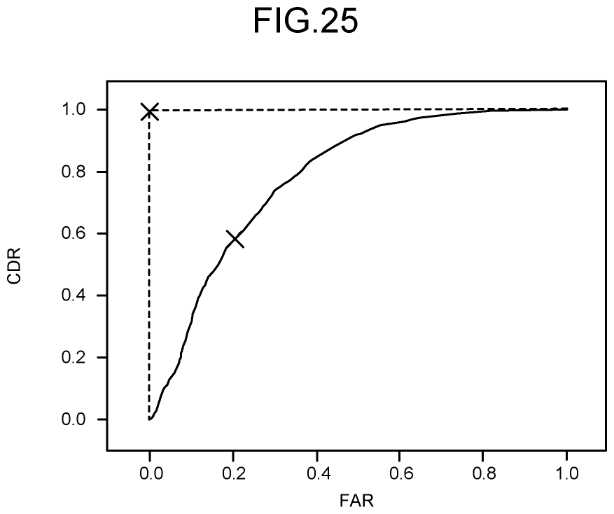

FIG. 25 is a diagram illustrating an example of an effect according to the twelfth embodiment of the present disclosure. The drawing is a diagram illustrating an ROC curve. CDR on the vertical axis in the drawing represents a ratio at which the falsified image can be correctly detected. In addition, FAR on the horizontal axis in the drawing represents a ratio at which an image without falsification is erroneously detected as an image with falsification. The CDR can be expressed by the following formula.

$$CDR = \frac{True Positive}{True Positive + False Negative} \qquad ( 3 )$$

In addition, the FAR can be expressed by the following formula.

$$FAR = \frac{False Positive}{False Positive + True Negative} \qquad ( 4 )$$

In the drawing, a dotted line graph represents a typical result of the comparison method. In addition, in the drawing, a solid line graph represents a result in a case where the technology of the present disclosure is applied. Although the area under the curve is 0.7843 in the result of the comparison method, 0.9948 has been achieved in the result of the technology of the present disclosure, indicating the effect of the technology of the present disclosure.

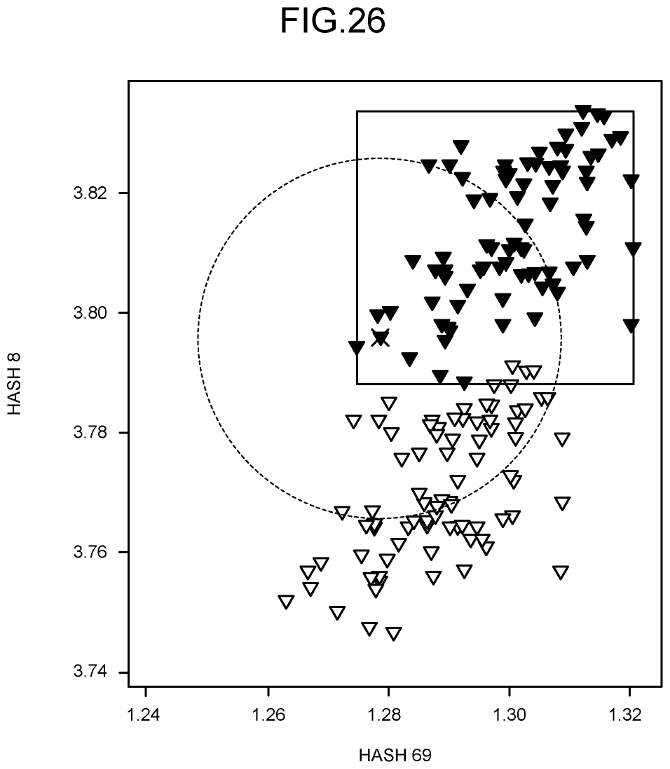

FIG. 26 is a diagram illustrating an example of a hash space according to the twelfth embodiment of the present disclosure. The drawing is a diagram illustrating spaces by 69th and 8th hashes in 144 dimensions. The vertical axis in the drawing represents a hash 8 which is the eighth hash. The horizontal axis in the drawing represents a hash 69 which is the 69th hash. Furthermore, a black triangle in the drawing represents a hash of an image without falsification. The one to which x is added represents the reference hash. A hollow triangle in the drawing represents a hash of an image with falsification.

For example, a Euclidean distance from the reference hash is used as an example of information regarding one-dimensional determination. A dotted circle is a comparative example in a case where the threshold value of the Euclidean distance is set to 0.03. In this case, it is difficult to distinguish an image without falsification from an image with falsification. On the other hand, a solid rectangle represents the case of the technology of the present disclosure. By using the technology of the present disclosure, it is possible to distinguish between an image without falsification and an image with falsification. This makes it possible to greatly improve the detection rate.

### Numerical Example 2

Compared to Numerical Example 1 described above, the hash region may be extended in the region size calculation units 145 and 146. It is assumed that hᵢ is a hash obtained by projecting the reference hash on the i-th axis, and that h_{max,i} and h_{min,i} are a maximum value and a minimum value, respectively, of the projection corresponding to the axis of a hash obtained by applying a plurality of specific processes to data. It is assumed that the signed distances before the region extension are ub=h_{max,i}−hᵢ, and lb=h_{min,i}−hᵢ. The region may be expanded as in the following expression using a and s as constants.

$${ub}^{′} = αmax ( {h}_{max , i} - {h}_{i} , ε )$$

$${lb}^{′} = αmin ( {h}_{min , i} - {h}_{i} , ε )$$

By expanding the region, an effect of reducing the number of a plurality of specific processes can be obtained. 0.001 is selected as ε, and α is used as a parameter in the ROC curve.

In the evaluation data set, there is a variation in which the above-described 81 pieces of predetermined process Pₑᵥₐₗ are applied to each image. Pₑᵥₐₗ is a process having a parameter different from that of the process P_{gen} used at the time of generation.

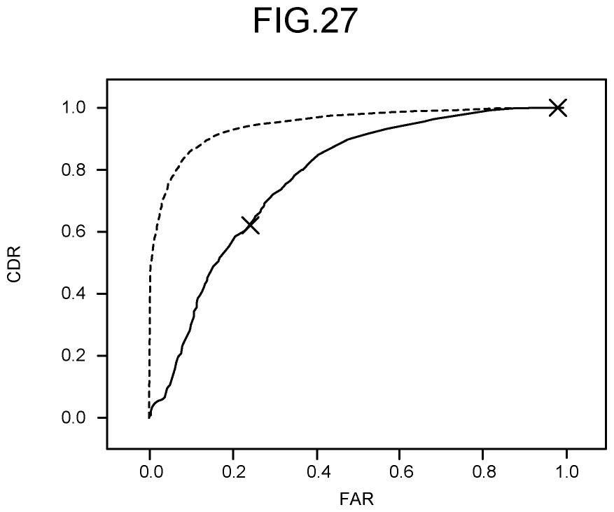

FIG. 27 is a diagram illustrating another example of an effect according to the twelfth embodiment of the present disclosure. The diagram represents an ROC curve. The drawing illustrates an ROC curve as in FIG. 26. Although the area under the curve is 0.7727 in the result of the comparison method, 0.9468 has been achieved in the result of the technology of the present disclosure, indicating the effect of the technology of the present disclosure.

The configuration of the system 1 other than this is similar to the configuration of the system 1 in the eleventh embodiment of the present disclosure, and thus description thereof is omitted.

### 13. Modification Example

A modification example of the present disclosure will be described by taking a system including an imaging element that generates an image as an example.

### [Configuration of System]

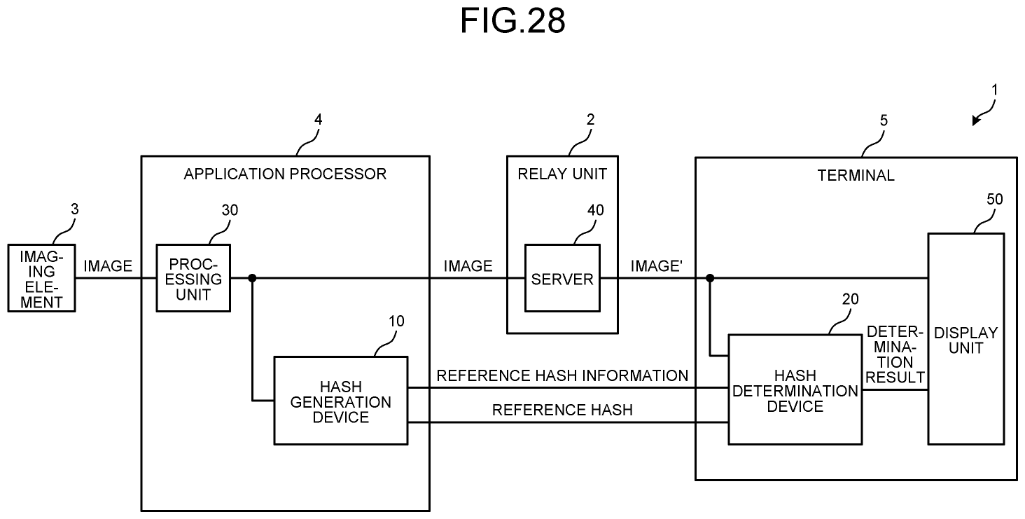

FIG. 28 is a diagram illustrating a configuration example of the system according to the modification example of the embodiment of the present disclosure. The drawing is a block diagram illustrating a configuration example of the system 1 as in FIG. 1. The system 1 in the drawing includes an imaging element 3, an application processor 4, a relay unit 2, and a terminal 5.

The imaging device 1 generates an image. The imaging device 1 can be constituted by a complementary metal oxide semiconductor (CMOS) image sensor, and captures light from a subject to convert the light into an image as digital data. The image is output to the application processor 4.

The application processor 4 processes an image. The processed image is transmitted to a server 40 of the relay unit 2. The application processor 4 includes a processing unit 30 and the hash generation device 10.

The processing unit 30 processes an image output from the imaging device 1. This image corresponds to a still image or a moving image. The processed image is transmitted to the server 40 and output to the hash generation device 10.

The hash generation device 10 in the drawing generates the reference hash information and the reference hash of the image processed by the processing unit 30. The generated reference hash information and reference hash are transmitted to the terminal 5 without passing through the relay unit 2.

The relay unit 2 in the drawing includes the server 40. The server 40 holds an image transmitted by the application processor 4. In addition, the server 40 transmits the held image to the terminal 5 on the basis of a request from the terminal 5. The drawing illustrates an example in which an image held in the server 40 is falsified into an image′. The image′ is transmitted to the terminal 5.

The terminal 5 captures and displays the image of the server 40. The terminal 5 in the drawing includes the hash determination device 20 and a display unit 50.

The hash determination device 20 in the drawing determines falsification of the image on the basis of the reference hash information and the reference hash transmitted from the application processor 4. The determination result is output to the display unit 50. In the drawing, the hash determination device 20 determines falsification of the image′. In this case, the hash determination device 20 can compare the determination hash generated from the image′ on the basis of the reference hash information with the reference hash, and can determine that the original image has been falsified.

The display unit 50 includes a liquid crystal panel or the like, and displays data such as an image acquired from the server 40 on the basis of a determination result of the hash determination device 20. When the determination result of the hash determination device 20 indicates no falsification, the image acquired from the server 40 is displayed. On the other hand, when the determination result of the hash determination device 20 indicates that there is falsification, the image acquired from the server 40 is not displayed.

### [Other Configuration of System]

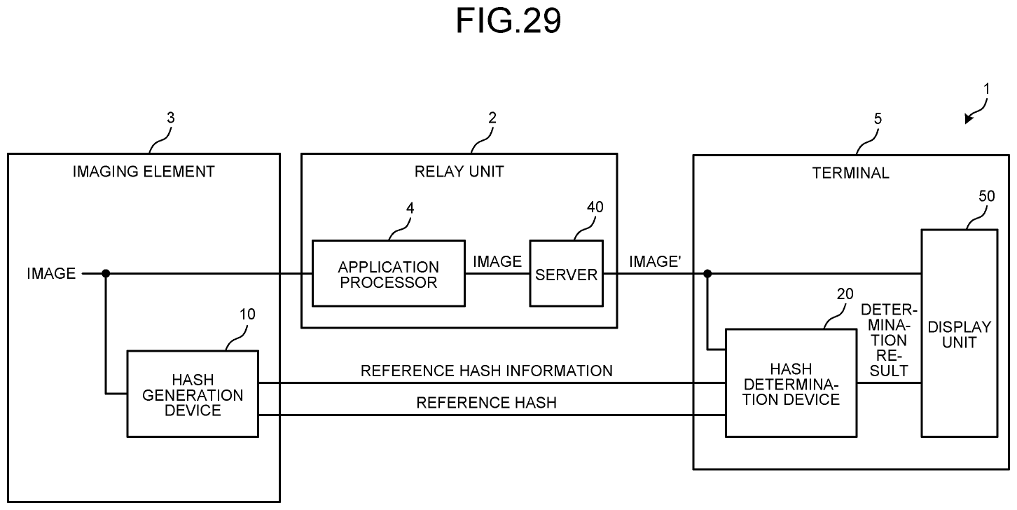

FIG. 29 is a diagram illustrating another configuration example of the system according to the modification example of the embodiment of the present disclosure. The drawing is a block diagram illustrating a configuration example of the system 1 as in FIG. 28. The imaging element 3 in the drawing images a subject, generates image data, and transmits the image data to the relay unit 2. Furthermore, the imaging element 3 in the drawing includes the hash generation device 10. The hash generation device 10 in the drawing generates the reference hash information and the reference hash of the image data, and transmits the reference hash information and the reference hash to the terminal 5.

The relay unit 2 in the drawing includes the application processor 4 and the server 40. The application processor 4 in the drawing processes an image transmitted from the imaging element 3. For this processing, the processing recognized as robust described in FIG. 1 can be applied.

The hash determination device 20 in the drawing can detect falsification of the image by the application processor 4 in addition to falsification of the image held in the server 40.

Note that, in the modification example of the present disclosure, timings or positions of elements constituting any drawing such as a block diagram or a flowchart are examples, and may be configured to be different. The embodiment described in each example has various modification examples. That is, the components of each example described may be partially omitted, partially or entirely changed, or partially or entirely modified. In addition, some of the components may be replaced with other components, or some or all of the components may be added with other components.

Further, a part or all of the components may be divided into a plurality of parts, a part or all of the components may be separated into a plurality of parts, or at least a part of the plurality of divided or separated components may have different functions or features. Moreover, at least a part of the components may be moved to form a different embodiment. Furthermore, a coupling element or a relay element may be added to at least a part of combinations of the components to form a different embodiment. In addition, a switching function or a selection function may be added to at least a part of combinations of the components to form a different embodiment.

The present embodiment is not limited to the configuration described in each example, and various modifications can be made without departing from the gist of the present technology. Note that the effects described in the present specification are merely examples and are not limited, and other effects may be provided.

In the present specification, processing performed by a computer according to a program is not necessarily performed in time series in the order described as a flowchart. That is, the processing performed by the computer according to the program also includes processing executed in parallel or individually (for example, parallel processing or processing by an object). Furthermore, the program may be processed by one computer (processor) or may be processed in a distributed manner by a plurality of computers. Furthermore, the program may be transferred to a remote computer and executed.

Moreover, in the present specification, the system means a set of a plurality of components (devices, modules (parts), and the like), and it does not matter whether or not all the components are in the same housing. Therefore, a plurality of devices housed in separate housings and connected via a network and one device in which a plurality of modules is housed in one housing are both systems. Furthermore, for example, a configuration described as one device (or processing unit) may be divided and configured as a plurality of devices (or processing units). Conversely, the configurations described above as a plurality of devices (or processing units) may be collectively configured as one device (or processing unit). Furthermore, it is a matter of course that a configuration other than those described above may be added to the configuration of each device (or each processing unit). Moreover, as long as the configuration and operation of the entire system are substantially the same, a part of the configuration of a certain device (or processing unit) may be included in the configuration of another device (or another processing unit).

Furthermore, for example, the present technology can employ a configuration of cloud computing in which one function is shared and processed by a plurality of devices in cooperation via a network. Furthermore, for example, the described program can be executed in any device. In that case, it is sufficient that the device has a necessary function (functional block or the like) and can obtain necessary information. Furthermore, for example, each step described in the flowchart can be executed by one device or can be shared and executed by a plurality of devices. Moreover, in a case where a plurality of processes is included in one step, the plurality of processes included in the one step can be executed by one device or can be shared and executed by a plurality of devices. In other words, a plurality of processes included in one step can also be executed as processes of a plurality of steps. Conversely, the processing described as a plurality of steps can be collectively executed as one step.

Note that, in the program executed by the computer, processing of steps describing the program may be executed in time series in the order described in the present specification, or may be executed in parallel or individually at necessary timing such as when a call is made. That is, as long as there is no contradiction, the processing of each step may be executed in an order different from the described order. Furthermore, the processing of steps describing this program may be executed in parallel with the processing of another program, or may be executed in combination with the processing of another program.

Note that a plurality of the present technologies described in the present specification can each be implemented independently as a single body as long as there is no contradiction. Of course, any plurality of the present technologies can be implemented in combination. For example, a part or all of the present technologies described in any of the embodiments can be implemented in combination with a part or all of the present technologies described in other embodiments. In addition, a part or all of any of the present technologies described can be implemented in combination with other technologies that are not described.

Note that the present technology can also have the following configurations.

(1)

A hash generation device, comprising:
a reference hash information generation unit that generates a plurality of pieces of reference hash information by a common process according to data, the plurality of pieces of reference hash information being information of a reference hash that is a hash generated from the data and is for use in determination of falsification of the data; and
a reference hash generation unit that generates the reference hash on a basis of the generated reference hash information.
   (2)

The hash generation device according to the above (1), wherein
the reference hash generation unit includes a feature amount extraction unit that extracts a feature amount of data, and a quantization unit that performs quantization processing of reducing the extracted feature amount and outputting the feature amount as the reference hash.
   (3)

The hash generation device according to the above (2), wherein
the reference hash generation unit further includes a preprocessing unit that performs preprocessing of processing the data before extraction processing of the feature amount, and
the feature amount extraction unit extracts a feature amount of the data after the preprocessing.
   (4)

The hash generation device according to the above (3), wherein
the data is data including an image,
the preprocessing unit performs low-pass filter processing on the data in directions of a plurality of coordinate axes as the preprocessing, and
the reference hash information generation unit generates, as the reference hash information, a plurality of pieces of information of a shape for each of the coordinate axes of a kernel of the low-pass filter processing.
(5)

The hash generation device according to the above (3), wherein
the data is data including an image,
the preprocessing unit performs, as the preprocessing, processing of reducing a size of the data along a plurality of coordinate axes, and
the reference hash information generation unit generates information of a size for each of the plurality of coordinate axes as the reference hash information.
   (6)

The hash generation device according to the above (3), wherein
the data is data including an image,
the preprocessing unit performs processing of dividing the data into a plurality of blocks as the preprocessing, and
the reference hash information generation unit generates information of a size for each of coordinate axes of the blocks as the reference hash information.
   (7)

The hash generation device according to the above (3), wherein
the data is data including an image,
the preprocessing unit performs processing of dividing the data into a plurality of blocks as the preprocessing, and
the reference hash information generation unit generates information of a number of the blocks for each of coordinate axes as the reference hash information.
   (8)

The hash generation device according to the above (3), wherein
the data is data including a character,
the preprocessing unit performs processing of dividing into blocks including the character in the data as the preprocessing, and
the reference hash information generation unit generates information of a size for each of coordinate axes of the blocks including the character as the reference hash information.
   (9)

The hash generation device according to the above (2), wherein
the reference hash information generation unit performs calculation processing of score on a plurality of bases for selecting a base to be used for feature amount extraction in the feature amount extraction unit, and generates information of a base selected on a basis of the calculated score as the reference hash information, and
the feature amount extraction unit extracts the feature amount on a basis of the generated reference hash information.
   (10)

The hash generation device according to the above (2), wherein
the data is data including a character,
the reference hash information generation unit detects a character portion center for each region of the character in the data and generates the detected character portion center as the reference hash information, and
the feature amount extraction unit projects the generated reference hash information as a projection center of the character portion to extract the feature amount.
   (11)

The hash generation device according to the above (2), wherein
the reference hash information generation unit generates a digit of rounding for each of the extracted feature amounts as the reference hash information, and
the quantization unit performs rounding processing based on the generated reference hash information as the quantization processing.
   (12)

The hash generation device according to the above (2), wherein
the feature amount extraction unit extracts a feature amount for a plurality of base groups including a plurality of bases used for feature amount extraction and generates a plurality of feature amount groups corresponding to the plurality of base groups,
the reference hash information generation unit performs calculation processing of score for each of the plurality of generated feature amount groups to generate a number of feature amounts for each of the feature amount groups as the reference hash information, and
the quantization unit performs the quantization processing by determining a feature amount corresponding to the number of feature amounts for each group on a basis of the generated reference hash information, and combining feature amounts on a basis of a comparison result of a relationship of the feature amounts in the group.
   (13)

The hash generation device according to the above (2), wherein
the feature amount extraction unit extracts a feature amount on a basis of a plurality of bases used for feature amount extraction,
the reference hash information generation unit generates a threshold value for binarizing the feature amount as the reference hash information, and
the quantization unit performs the quantization processing by binarizing the extracted feature amount on a basis of the generated reference hash information.
   (14)

The hash generation device according to the above (2), wherein
the reference hash information generation unit generates a hash region including a plurality of hashes as the reference hash information.
   (15)

The hash generation device according to the above (14), wherein
the reference hash information generation unit processes the data by a plurality of specific processes, generates a plurality of feature amounts for each processing result, generates hashes one by one for the plurality of specific processes, and generates the hash region including the plurality of generated hashes as the reference hash information.
   (16)

The hash generation device according to the above (15), wherein
the reference hash information generation unit generates a region represented by polar coordinates centered on the reference hash as the hash region.
   (17)

A hash determination device including:
a determination hash generation unit that generates a determination hash that is a hash of data on a basis of a plurality of pieces of reference hash information generated by a common process according to the data, the plurality of pieces of reference hash information being information of a reference hash that is a hash generated from the data and is for use in determination of falsification of own data; and
a determination unit that determines falsification of the data on a basis of the generated determination hash and the reference hash.
   (18)

The hash determination device according to the above (17), wherein
the reference hash information is a hash region configured by a plurality of hashes, and
the determination unit performs the determination on a basis of whether the generated determination hash is included in a hash region on a basis of the reference hash information.
   (19) A system comprising:
a hash generation device including
a reference hash information generation unit that generates a plurality of pieces of reference hash information by a common process according to data, the plurality of pieces of reference hash information being information of a reference hash that is a hash generated from the data and is for use in determination of falsification of the data, and
a reference hash generation unit that generates the reference hash on a basis of the generated reference hash information; and
a hash determination device including
a determination hash generation unit that generates a determination hash that is a hash of the data on a basis of the plurality of pieces of reference hash information, and
a determination unit that determines falsification of the data on a basis of the generated determination hash and the reference hash.
   (20)

A hash generation method, including:
generating a plurality of pieces of reference hash information by a common process according to data, the plurality of pieces of reference hash information being information of a reference hash that is a hash generated from the data and is for use in determination of falsification of the data; and
generating the reference hash on the basis of the generated reference hash information.
   (21)

A hash determination method, including:
generating a determination hash that is a hash of data on the basis of a plurality of pieces of reference hash information generated by a common process according to the data, the plurality of pieces of reference hash information being information of a reference hash that is a hash generated from the data and is for use in determination of falsification of own data; and
determining falsification of the data on the basis of the generated determination hash and the reference hash.

### REFERENCE SIGNS LIST

1 SYSTEM
10 HASH GENERATION DEVICE
20 HASH DETERMINATION DEVICE
100 REFERENCE HASH INFORMATION GENERATION UNIT
171, 271 PREPROCESSING UNIT
172, 272 FEATURE AMOUNT EXTRACTION UNIT
173, 273 QUANTIZATION UNIT
200 DETERMINATION UNIT
270 DETERMINATION HASH GENERATION UNIT

1. A hash generation device, comprising:
a reference hash information generation unit that generates a plurality of pieces of reference hash information by a common process according to data, the plurality of pieces of reference hash information being information of a reference hash that is a hash generated from the data and is for use in determination of falsification of the data; and
a reference hash generation unit that generates the reference hash on a basis of the generated reference hash information.

2. The hash generation device according to claim 1, wherein
the reference hash generation unit includes a feature amount extraction unit that extracts a feature amount of data, and a quantization unit that performs quantization processing of reducing the extracted feature amount and outputting the feature amount as the reference hash.

3. The hash generation device according to claim 2, wherein
the reference hash generation unit further includes a preprocessing unit that performs preprocessing of processing the data before extraction processing of the feature amount, and
the feature amount extraction unit extracts a feature amount of the data after the preprocessing.

4. The hash generation device according to claim 3, wherein
the data is data including an image,
the preprocessing unit performs low-pass filter processing on the data in directions of a plurality of coordinate axes as the preprocessing, and
the reference hash information generation unit generates, as the reference hash information, a plurality of pieces of information of a shape for each of the coordinate axes of a kernel of the low-pass filter processing.

5. The hash generation device according to claim 3, wherein
the data is data including an image,
the preprocessing unit performs, as the preprocessing, processing of reducing a size of the data along a plurality of coordinate axes, and
the reference hash information generation unit generates information of a size for each of the plurality of coordinate axes as the reference hash information.

6. The hash generation device according to claim 3, wherein
the data is data including an image,
the preprocessing unit performs processing of dividing the data into a plurality of blocks as the preprocessing, and
the reference hash information generation unit generates information of a size for each of coordinate axes of the blocks as the reference hash information.

7. The hash generation device according to claim 3, wherein
the data is data including an image,
the preprocessing unit performs processing of dividing the data into a plurality of blocks as the preprocessing, and
the reference hash information generation unit generates information of a number of the blocks for each of coordinate axes as the reference hash information.

8. The hash generation device according to claim 3, wherein
the data is data including a character,
the preprocessing unit performs processing of dividing into blocks including the character in the data as the preprocessing, and
the reference hash information generation unit generates information of a size for each of coordinate axes of the blocks including the character as the reference hash information.

9. The hash generation device according to claim 2, wherein
the reference hash information generation unit performs calculation processing of score on a plurality of bases for selecting a base to be used for feature amount extraction in the feature amount extraction unit, and generates information of a base selected on a basis of the calculated score as the reference hash information, and
the feature amount extraction unit extracts the feature amount on a basis of the generated reference hash information.

10. The hash generation device according to claim 2, wherein
the data is data including a character,
the reference hash information generation unit detects a character portion center for each region of the character in the data and generates the detected character portion center as the reference hash information, and
the feature amount extraction unit projects the generated reference hash information as a projection center of the character portion to extract the feature amount.

11. The hash generation device according to claim 2, wherein
the reference hash information generation unit generates a digit of rounding for each of the extracted feature amounts as the reference hash information, and
the quantization unit performs rounding processing based on the generated reference hash information as the quantization processing.

12. The hash generation device according to claim 2, wherein
the feature amount extraction unit extracts a feature amount for a plurality of base groups including a plurality of bases used for feature amount extraction and generates a plurality of feature amount groups corresponding to the plurality of base groups,
the reference hash information generation unit performs calculation processing of score for each of the plurality of generated feature amount groups to generate a number of feature amounts for each of the feature amount groups as the reference hash information, and
the quantization unit performs the quantization processing by determining a feature amount corresponding to the number of feature amounts for each group on a basis of the generated reference hash information, and combining feature amounts on a basis of a comparison result of a relationship of the feature amounts in the group.

13. The hash generation device according to claim 2, wherein
the feature amount extraction unit extracts a feature amount on a basis of a plurality of bases used for feature amount extraction,
the reference hash information generation unit generates a threshold value for binarizing the feature amount as the reference hash information, and
the quantization unit performs the quantization processing by binarizing the extracted feature amount on a basis of the generated reference hash information.

14. The hash generation device according to claim 2, wherein
the reference hash information generation unit generates a hash region including a plurality of hashes as the reference hash information.

15. The hash generation device according to claim 14, wherein
the reference hash information generation unit processes the data by a plurality of specific processes, generates a plurality of feature amounts for each processing result, generates hashes one by one for the plurality of specific processes, and generates the hash region including the plurality of generated hashes as the reference hash information.

16. The hash generation device according to claim 15, wherein
the reference hash information generation unit generates a region represented by polar coordinates centered on the reference hash as the hash region.

17. A hash determination device including:
a determination hash generation unit that generates a determination hash that is a hash of data on a basis of a plurality of pieces of reference hash information generated by a common process according to the data, the plurality of pieces of reference hash information being information of a reference hash that is a hash generated from the data and is for use in determination of falsification of own data; and
a determination unit that determines falsification of the data on a basis of the generated determination hash and the reference hash.

18. The hash determination device according to claim 17, wherein
the reference hash information is a hash region configured by a plurality of hashes, and
the determination unit performs the determination on a basis of whether the generated determination hash is included in a hash region on a basis of the reference hash information.

19. A system comprising:
a hash generation device including
a reference hash information generation unit that generates a plurality of pieces of reference hash information by a common process according to data, the plurality of pieces of reference hash information being information of a reference hash that is a hash generated from the data and is for use in determination of falsification of the data, and
a reference hash generation unit that generates the reference hash on a basis of the generated reference hash information; and
a hash determination device including
a determination hash generation unit that generates a determination hash that is a hash of the data on a basis of the plurality of pieces of reference hash information, and
a determination unit that determines falsification of the data on a basis of the generated determination hash and the reference hash.
